(19) United States
(12) Patent Application Publication
(10) Pub. No.: US 2017/0038605 A1
(43) Pub. Date: Feb. 9, 2017

(54) OPHTHALMIC EYEWEAR FOR REGULATING OCULAR EXPOSURE TO HIGH ENERGY ELECTROMAGNETIC RADIATION

(71) Applicant: LEGERTON A Jerome, Jupiter, FL (US)

(72) Inventor: Jerome A. Legerton, Jupiter, FL (US)

(21) Appl. No.: 15/303,076

(22) PCT Filed: Apr. 10, 2015
(86) PCT No.: PCT/IB15/52633

§ 371 Date: Oct. 10, 2016

Related U.S. Application Data
(60) Provisional application No. 61/978,360, filed on Apr. 11, 2014.

(51) Int. Cl. G02C 7/10; G02C 7/04; G02C 7/02

(52) U.S. Cl. CPC G02C 7/104; G02C 7/101; G02C 7/02; G02C 7/04; G02C 7/102; G02C 2202/16

(57) ABSTRACT

Ophthalmic eyewear is provided, comprising a frame and a spectacle lens having a filter and being disposed within the frame or a contact lens having a filter disposed thereon or therein. The filter comprises a spectral characteristic that modulates the transmission of ambient light to protect the eyes of the wearer from damage and loss of vision caused by high energy wavelengths of light.

### BACKGROUND

Field

The present invention relates generally ophthalmic eyewear. More particularly, the present invention relates to aesthetically acceptable ophthalmic eyewear for modulating the transmission of ambient light to protect the eyes of the wearer from damage and loss of vision caused by high energy wavelengths of light, yet without blocking the transmission of light that contributes to alertness and well-being.

Discussion of the Related Art

Conventional spectacle eyewear has been produced by the process of first manufacturing frames or frame components followed by cutting and edging lenses to fit the frame or mounting together by a bridge, and including end-pieces to which temples or earpieces are attached. The spectacle lenses can be produced in an uncut form by way of casting or molding a semi-finished blank with one surface complete and surfacing the opposing surface to create a finished prescription (e.g., power), by casting or molding a lens wherein both surfaces are finished, or by surfacing both surfaces of the lenses as in free form lens processing. It is often desirable to avoid off-color, aesthetically undesirable tints (e.g., yellow) to the lenses, where feasible.

Age Related Macular Degeneration (AMD) is a disease of increasing prevalence wherein central visual acuity is lost rendering the individual unable to see detail when viewing distance or near visual stimuli. The condition is known to proceed to the level of legal blindness or beyond. Basic research has established the role of high energy blue light along with near visible ultraviolet light in what is called photoretinitis and resultant photoreceptor death. The confluence of photonics and molecular biology is connected by a model of cellular transduction in which enzymes alter the oxygen supply to the retinal cells in response to the energy from the blue light. The resultant photo-oxidative stress is reported as the mechanism for biological changes.

Roehlecke et al. (Molecular Vision, 2011) studied explanted retinal cells irradiated with blue light of 405 nm. They concluded that blue light of this wavelength had detrimental effects on the photoreceptors as evidenced by cell death from exposure. This wavelength is shorter than the wavelength cited by other researchers and the wavelength of concern in other preventive light modulation strategies.

U.S. Pat. Nos. 7,976,157 and 8,342,681 to Croft et al. disclose stock computer eyewear comprising first and second lens portions for viewing a screen, and a frame portion to support the first and second lens portions. The first and second lens portions are configured to selectively attenuate the transmission of a spectral peak in the emission of fluorescent lighting through the first and second lens portions. These patents further disclose computer eyewear comprising first and second powered lens portions with substantially equal optical power to provide non-prescription correction for viewing a computer screen, and a frame portion disposed about said first and second lens portions to provide support. The first and second lens portions include an optical filter whose transmission curve in the visible spectrum has a feature that coincides with at least one spectral peak in the emission of fluorescent lighting, the feature being located at about 440 nm and having a width of about 25 nm, wherein the effect of the feature is to selectively attenuate the transmission of the spectral peak through the optical filter.

Thus, the Croft patents are directed toward providing a tint or filter that blocks a portion of the visible blue light found in fluorescent lighting. Disadvantageously, these wavelengths approximate wavelengths required to produce the full spectrum of colors in a computer display. The Croft patents are limited to ready-made or stock eyewear having the claimed filter with the use of a low plus power, what appears to be a horizontal prismatic addition, and a frame which has a relationship with the average facial bone structure to provide a proximity to the face which is intended to create a higher humidity behind the eyewear than in the ambient environment of the user.

One shortcoming of the Croft patents is the failure to provide adequate filtering of wavelengths surrounding 405 nm while at the same time disadvantageously blocking an excess of light in the bandwidth of 450 to 500 nm which is required for the non-visual retinal hypothalamic tract to suppress melatonin for the maintenance of an alert mental state of the wearer along with an optimum emotional state in those suffering Seasonal Affective Disorder. Another shortcoming is the failure to transmit light in the bandwidth from 480 to 700 to an optimum degree for night driving or ambient indoor lighting.

U.S. Pat. No. 8,360,574 to Ishak et al. discloses an ophthalmic system comprising a selective light wavelength filter that selectively filters 5-50% of light in a range of blue light wavelengths in the hazardous range that includes 430 nm. Ishak also discloses an ophthalmic system comprising a selective light wavelength filter that blocks 5-50% of light having a wavelength in the range of 400-460 nm. Ishak attempts to balance the appearance of the lens as having an undesirable yellow hue and to maintain an overall light transmission of 80%. However, the low level of blue light filtering disadvantageously fails to respect conditions in which an individual is exposed to high levels of hazardous blue light.

Further, Ishak fails to teach the filtering of electromagnetic radiation shorter in wavelength than 400 nm. The Ishak patent also fails to reduce the transmission of the hazardous wavelengths surrounding 405 nm by more than 50%, thereby exposing the eye and retina to dangerous levels of the highest energy blue light. Because the Ishak patent fails to transmit a full level of the 450 to 500 nm bandwidth, it fails to stimulate the non-visual retinal hypothalamic tract to suppress melatonin for the maintenance of an alert mental state of the wearer along with an optimum emotional state in those suffering Seasonal Affective Disorder.

U.S. Pat. No. 6,995,430 to Pratt discloses an article of externally-worn eye wear which is designed to minimize glare, contrast sensitivity, chromatic and spherical aberrations and color distortion while maximizing visual acuity and blockage of light wavelength transmission throughout the blue light spectrum. More specifically, the eye wear has a wavelength transmission blocker for blocking substantially 100% of transmission of light wavelengths that are between 400 nm and 510 nm. In one disclosed embodiment, the wavelength transmission blocker also blocks ultraviolet A wavelengths, ultraviolet B wavelengths, infrared wavelengths, and combinations thereof. The wavelength transmission blocker can be a tint composition disposed exteriorly upon the lens, or it can be a tint composition disposed interiorly within the lens.

U.S. Pat. No. 7,255,435 to Pratt discloses an article of eye wear worn externally upon an eye, the article comprising a wavelength transmission blocker having a lutein assimilated therein for preventing radical damage in the eye, the wavelength transmission blocker being sized and configured to maximize visual acuity and block at least 80% of light wavelengths throughout a blue light spectrum set in a range from about 400 nm to about 510 nm.

Pratt further discloses an article of eye wear, comprising a wavelength transmission blocker being sized and configured to block predetermined percentages of light transmission at selective wavelengths, wherein the predetermined percentages are substantially 100% at wavelengths up to 400 nm; and gradually reduced from about 99% at wavelength of 420 nm to about 80% at wavelength of 510 nm. Because the Pratt patents teach blocking 100% or between 99% at 420 nm to about 80% at 510 nm, they fail to transmit the blue light wavelength from an electronic display to the level required for normal color separation and balance. Further, the Pratt patents fail to transmit a full level of the 450 to 500 nm bandwidth required for the non-visual retinal hypothalamic tract to suppress melatonin for the maintenance of an alert mental state of the wearer along with an optimum emotional state in those suffering Seasonal Affective Disorder.

U.S. Pat. No. 8,047,650 to Mainster discloses an ophthalmic device comprising a vertical cut-off filter incorporated therein, wherein the vertical cut-off filter abruptly absorbs light between the wavelength of between approximately 400 nm and 450 nm, the vertical cut-off filter being less than the entire ophthalmic device and comprising a violet light absorbing dye, wherein the vertical cut-off filter increases transmittance from about 0% at 400 nm to greater than 80% at 450 nm.

Disadvantageously the vertical cut-off filter taught by Mainster results in a transmission of more than 50% of the hazardous wavelengths at or about 410 to 420 nm. The low level of blue light filtering disadvantageously fails to respect conditions in which an individual is exposed to high levels of hazardous blue light with wavelengths from 410 to 450 nm.

Thus, although the prior art provides for some reduction of the blue light hazard in a non-specific way (Croft), in a partial transmission reduction (Ishak), and to an excessive degree (Pratt) and in a narrow bandwidth (Mainster) it fails to respect the importance of providing varying amounts of filtration above 50% across a bandwidth from 400 to 450 nm for wearers' having environmental hazards with different intensities of blue light. The prior art is limited in the ability to provide individual protection for the blue light hazards presented in the respective environment and vocational and life-style demands of the individual.

More specifically, the Croft, Ishak, Pratt and Mainster patents each fail to consider the range of spectral characteristics and intensities of the natural and artificial light sources in the environment of the wearer. The Croft, Ishak, Pratt and Mainster patents provide for only passive and fixed filtering and fail to consider the significant variation of the intensity of harmful blue light bandwidths presented to a single individual and the full continuum of individuals. Moreover, Croft, Ishak, Pratt and Mainster fail to teach prescribing an amount of filtering which correlates to the measured blue light hazard of at least one environmental exposure setting of the wearer.

Thus, there remains a need to provide a protective ophthalmic system which filters more than 50% of high energy blue light in the range of 400 to 460 nm while transmitting the bandwidths needed for high proper color balance and contrast when viewing of a computer display and while transmitting the bandwidths needed to maintain proper circadian rhythm and freedom from the stimulus for Seasonal Affective Disorder, yet blocking substantially all of the ultraviolet bandwidth shorter than 400 nm. There also remains a need to provide individual filter prescriptions based on the measured presence of hazardous blue light in the visual environment of the respective wearer.

### SUMMARY

Embodiments of the present disclosure are directed toward the protection from high energy electromagnetic radiation and prevention of Age Related Macular Degeneration (AMD). In particular, some embodiments are directed toward correcting the problem of filtering ultraviolet radiation and high energy blue light while transmitting the band of blue light required for maintenance of normal circadian rhythm and the spectra of visible light in indoor environments and ambient night time outdoor environments.

Further embodiments of the present disclosure address the need to reduce the excess high energy blue light from electronic devices and electronic displays. The health risks of high energy blue light are widely accepted and include photoretinitis with subsequent photoreceptor apoptosis.

Embodiments of the present disclosure address various problems to protect eye health, improve visual performance, and maintain sound mental and sound emotional states when exposed to electromagnetic radiation including high energy blue light. These problems include, but are not limited to: (i) the brightness of broadband light in the environment which is directed toward the eye; (ii) the spectral character and intensity of the light from natural and artificial sources; (iii) the age of the wearer; (iv) the pupil size of the wearer; and (v) that more than fifty percent of the population require prescriptions for correcting refractive errors and presbyopia (such users also have phorias and binocular vision correction requirements).

Various embodiments of the present disclosure are directed to ophthalmic eyewear comprising a frame and a spectacle lens having a filter and being disposed within the frame. The filter comprises a spectral characteristic that selectively transmits broadband light from natural and artificial lighting and red, green and blue light as mixed and emitted by artificial sources such as an electronic display, while blocking more than fifty percent of the bandwidth surrounding 405 nm.

Another embodiment of the present disclosure is directed to a system and method of measuring at least one environmental setting of the wearer and prescribing a level of filtering to reduce the respective blue light hazard of the environment.

Another embodiment provides ophthalmic eyewear comprising a contact lens having a filter, wherein the filter comprises a spectral characteristic that selectively transmits broadband light from natural and artificial lighting and red, green and blue light as mixed and emitted by artificial sources such as an electronic display, while blocking more than fifty percent of the bandwidth surrounding 405 nm.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure.

FIG. 1 is a perspective view illustrating spectacle lens ophthalmic eyewear comprising a spectacle lens having a filter and being disposed within a frame according to an embodiment of the present disclosure.

FIG. 2 is a front view illustrating contact lens ophthalmic eyewear comprising a contact lens having a filter according to an embodiment of the present disclosure.

FIG. 3 is a graph representing a schematic of the transmission of a filter representative of an embodiment of the present disclosure.

FIG. 4 is a graph representing a schematic of the transmission of a filter representative of an alternate embodiment of the present disclosure providing greater transmission of the wavelengths surrounding 405 nm.

FIG. 5 is flow diagram illustrating the system and method for determining the filtering characteristics of lenses representative of an embodiment of the present disclosure.

FIG. 6 is a front view illustrating a spectacle lens ophthalmic eyewear comprising a sensor, a processor, a power source, and an electro-chromic lens according to an embodiment of the present disclosure.

### DETAILED DESCRIPTION

The present disclosure relates to the protection from high energy electromagnetic radiation and prevention of Age Related Macular Degeneration (AMD) as well as offering aesthetically acceptable eyewear that does not block the transmission of light that contributes to alertness and well-being. Persons skilled in the art will readily appreciate that various aspects of the present disclosure can be realized by any number of devices and methods configured to perform the intended functions. Stated differently, other devices and methods can be incorporated herein to perform the intended functions. It should also be noted that the accompanying drawing figures referred to herein are not all drawn to scale, but may be exaggerated to illustrate various aspects of the present disclosure, and in that regard, the drawing figures should not be construed as limiting. Likewise, different surface shading may be used throughout the figures to denote different parts but not necessarily to denote the same or different materials. Finally, although the present disclosure can be described in connection with various principles and beliefs, the present disclosure should not be bound by theory.

Various embodiments of the present disclosure are directed to spectacle lens ophthalmic eyewear that include ophthalmic lenses and contact lenses. An ophthalmic lens can be a spectacle lens or a lens mounted in ophthalmic eyewear manufactured from any known or as yet unknown material suitable for use by a wearer. The ophthalmic eyewear may include a right lens and a left lens. The eyewear may be designed to sit in the spectacle plane or in another plane as in a goggle or other head mounted format.

A contact lens may comprise any lens configured to be positioned in direct contact with a wearer's eye. The contact lens can be a soft lens, rigid lens, hybrid lens, intracorneal lens, corneal onlay, or intraocular lens, manufactured from any suitable material or combination of materials such as, for example, one or more of fluorosilicon acrylate, silicon acrylate, polymethylmethacrylate, a silicon hydrogel, or other biocompatible materials and/or suitably transparent materials, and the like, which can be soft, rigid or a combination of soft and rigid, and which are suitable for the machining, casting or other processing necessary to manufacture the lens.

In accordance with various embodiments of the present disclosure, the lenses incorporate a filter that regulates spectral transmission of the lens, namely to reduce the specific blue light hazard of an individual wearer. In these embodiments, the percent transmission of the blue light bandwidth is reduced relative to the percent transmission of the red bandwidth and the green bandwidth. In some embodiments, an ophthalmic lens includes the individual lens prescription along with the filtering for the bandwidths of the electronic device used by the individual, while also providing protection from the hazards of specific wavelengths.

In some embodiments, the center of each band, the width and the percent transmission is customized for each individual. Embodiments of the present disclosure are directed toward producing ophthalmic lenses which are customized for the particular light conditions of the individual user.

In various embodiments, the spectral transmission is expanded in the blue bandwidth to allow the wavelength from about 460 to about 500 nm to serve as a zeitgeber for the purpose of stimulating the retinal-hypothalamic tract to prevent the release of melatonin, which in turn contributes to a feeling of fatigue consistent with the circadian rhythm response to dim light absent of this wavelength. This element uses artificial and natural light sources to assist maintenance of an alert mental state along with an emotional state less likely to result in depression associated with Seasonal Affective Disorder.

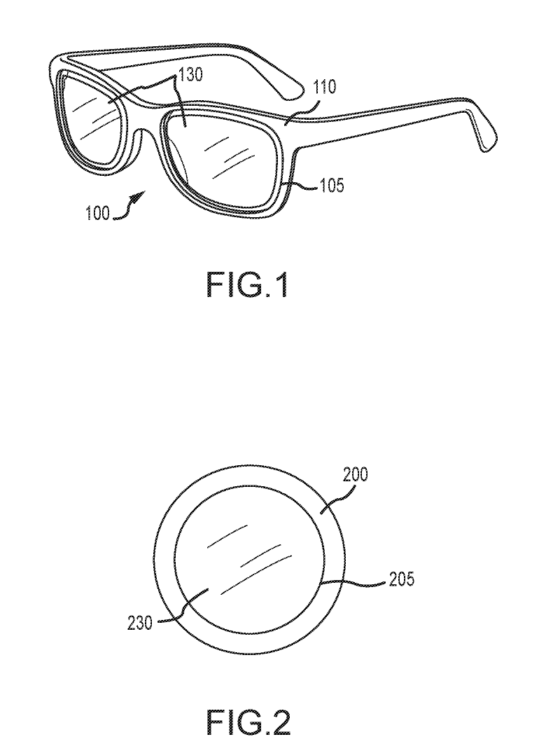

With reference to FIG. 1, an embodiment of a spectacle lens ophthalmic eyewear 100 comprising a spectacle lens 105 having a filter 130 and being disposed within a frame 110 is illustrated. In this embodiment and as described in more detail below, the spectacle lens 105 comprises a filter 130 having spectral characteristics that transmit the red, green and blue light as mixed and emitted by an electronic display and the ambient environment, while blocking more than about 50% of light in a bandwidth with a center at about 405 nm and transmitting more than about 50% of light with a wavelength of greater than about 460 nm. Other types of filters, such as those discussed herein, may be employed without departing from the scope of the present disclosure. In the illustrated embodiment, the filter 130 covers only a portion of the spectacle lens 105, specifically, a portion of the lens 105 where the majority of light transmission occurs, such that a peripheral portion of the lens 105 is unfiltered, though in other embodiment, the filter 130 covers the entire lens 105.

The filter 130 may be comprised of a spectral filter material in the substrate of the lens in combination with a surface filter. By example, the substrate may include a ultraviolet absorber to reduce the transmission of the non-visible ultra-violet light with or without an additional tint for filtering a portion of the high energy blue light. In addition, a surface filter in the form of a multilayer coating, rugate, or dielectric stack may be added to produce a final lens having a spectral transmission in accordance with the present disclosure.

In one embodiment, the ultraviolet absorber is throughout the substrate while the surface filter is in a gradient format having greater filtering in the upper portion of the lens and lesser filtering in the lower portion of the lens.

A dielectric coating can be fabricated by mixtures of two different coating materials with a variable mixing ratio. In one example, a double electron beam co-evaporation or similar methods may be used (e.g., using resistance heating or ion beam sputtering) with material pairs such as ZrO₂/MgO, ZrO₂/SiO₂, Ta₂O₅/TiO₂ or TiO₂/SiO₂. Depending on the detailed composition, substrate and temperature, polycrystalline or amorphous structures are produced.

For some coating materials such as TiO₂, the packing density can be varied during vapor deposition, by control of the oxygen partial pressure or by glancing angle deposition. The packing density directly affects the refractive index. Such techniques are also applied to porous silicon rugate filters

The surface filter may be produced by electron beam deposition by the evaporation of material in a crucible by heating with an electron beam, which can be generated from a hot filament and focused with a magnetic field. In the vacuum chamber, the evaporated material moves to the substrate, which can be covered with a mechanical shutter as soon as the right amount of material has been deposited. The target substrate is heated to improve the quality. A similar method uses evaporation by resistive heating of the crucible.

Ion-assisted deposition (IAD) may also be employed like electron beam evaporation, but involves an additional ion beam (e.g., consisting of oxygen and/or argon ions) which hits the target substrate. The comparatively high energy of the ions allows a reordering of the deposited material, leading to denser coatings, even without heating the substrate. The method is appropriate for oxide coatings, by example SiO₂ or TiO₂.

Ion beam sputtering (IBS) uses an ion beam which, after neutralization with a second filament, hits a metal or metal oxide target to sputter material to the substrate. The flux and energy of the ions can be controlled independently and precisely. IBS generates uniform, non-porous coatings with good adhesion and very low surface roughness and is well reproducible.

Advanced plasma reactive sputtering (APRS) involves the sputtering of thin metal films, which are subsequently oxidized in a separate oxygen plasma region of the chamber. Separate magnetron sources are used for the different coating materials. APRS combines a high precision and high density of the coatings with a high speed.

Common coating materials are oxides such as SiO₂, TiO₂, Al₂O₃ and Ta₂O₅, and fluorides such as MgF₂, LaF₃ and AlF₃.

Electrochromic materials pertaining to transition-metal hydride electrochromics may be employed as reflective hydrides, which become reflective rather than absorbing, and thus switch states between transparent and mirror-like.

Additional embodiments may be comprised of modified porous nano-crystalline films consisting of several stacked porous layers printed on top of each other on a substrate modified with a transparent conductor.

Additionally, in some embodiments, a polymer dispersed liquid crystal (PDLC) technology may be employed wherein liquid crystals are dissolved or dispersed into a liquid polymer followed by solidification or curing of the polymer. During the change of the polymer from a liquid to solid, the liquid crystals become incompatible with the solid polymer and form droplets throughout the solid polymer. Curing conditions affect the size of the droplets that in turn affect the final operating properties of the electrochromic lens. The liquid mix of polymer and liquid crystals may be placed between two layers of glass or plastic that include a thin layer of a transparent, conductive material followed by curing of the polymer, thereby forming the basic sandwich structure of the electrochromic lens.

In another embodiment, an electrochromic lens can use nanocrystals. A thin coating of nanocrystals embedded in a substrate can provide selective control over visible light when activated by electrical current.

With reference now to FIG. 2, an embodiment of contact lens ophthalmic eyewear 200 comprising a contact lens 205 having a filter 230 is illustrated.

The filter 230 comprises spectral characteristics that transmit the red, green and blue light as mixed and emitted by an electronic display and the ambient environment, while blocking more than about 50% of light in a bandwidth with a center at about 405 nm and transmitting more than about 50% of light with a wavelength of greater than about 460 nm. In the illustrated embodiment, the filter 230 covers only a portion of the entire contact lens 205, specifically, a generally central portion of the lens 205, such that a peripheral portion of the lens 205 is unfiltered. In another embodiment, the filter 230 covers the entire lens 205.

The filter 230 may include filters comprising tints or colorants. The term “colorant” is used herein in its art-recognized meaning to denote any substance that imparts color to another material or mixture, and to include white, black and grey as well as materials which impart hues in accordance with art-recognized usage. The colorants used herein are materials which alter the spectral transmittance curve of the matrix polymer. One or more UV absorbers and one or more additional colorants may be used as necessary to obtain a desired spectral transmittance curve in a finished lens. Additionally, examples for a rigid lens and a soft lens are described herein, but one skilled in the art will appreciate that other colorants and tints may be used for different rigid lenses, soft lenses or hybrid lenses.

For example, in an embodiment, a rigid lens starting formulation can include one or more colorants or colorant precursors, which may be polymerizable or non-polymerizable. Polymerizable colorants or colorant precursors include acryloxy- or methacryloxy-substituted 2,4-dihydroxybenzophenonic compounds such as 2-hydroxy-4-methacryloxybenzophenone, 2-hydroxy-4-(3-methacryloxy-2-hydroxypropyl)benzophenone and 2,2′-dihydroxy4,4′-di(3-methacryloxy-2-hydroxypropyl)benzophenone. Polymerizable colorants or colorant precursors copolymerize with the principal monomer or monomers and thus become a chemically balanced part of a polymer molecule.

Non-polymerizable colorants are materials which do not undergo polymerization and which become physically trapped in the polymer matrix material which is formed on polymerization. Exemplary non-polymerizable colorants include ultraviolet (UV) absorbers such as 2,2′,4,4′-tetrahydroxybenzophenone and 2,2′-dihydroxy-4,4′-dimethoxybenzophenone. Other UV-absorbing benzophenones now known or as yet unknown in the art and may be used herein.

Other colorants which may be used in the preparation of hard contact lenses or other rigid lenses according to this invention include the following: 4-[(2,4-dimethylphenyl)azo]-2,4-dihydro-5-methyl-2-phenyl-3H-pyrazol-3-one; 1,4-bis[(4-methylphenyl)amino]-9,10-anthracenedione; and 1,hydroxy-4-[(4-methylphenyl)amino]-9,10-anthracenedione.

For example, in an embodiment of a soft lens, a portion of a hydrophilic lens is colored or tinted by application of two or more reactive dyes vat dyes or other dyes or pigments. The reactive dyes together can impart a transmittance curve such that the lens has the transmittance characteristics described herein. Exemplary reactive dyes which can be used in the practice of this invention include the following: benzene sulfonic acid, 4-(4,5-dihydro-4-((2-methoxy-5-methyl-4-((2-(sulfooxy)ethyl)sulfonyl)phenyl)azo-3-methyl-5-oxo-1H-pyrazol-1-yl); [2-naphthalenesulfonic acid, 7-(acetylamino)-4-hydroxyl-3-((4-((sulfooxyethyl)sulfonyl)phenyl)azo)-]; [5-((4,6-dichloro-1,3,5-triazin-2-yl)amino-4-hydroxy-3-((1-sulfo-2-naphthalenyl)azo-2,7-naphthalene-disulfonic acid, trisodium salt]; [copper, 29H, 31H-phthalocyaninato(2-)-N.sub.29, N.sub.30, N.sub.31, N.sub.32)-, sulfo((4-((2-sulfooxy)ethyl)sulfonyl)phenyl)amino)sulfonyl derivative]; and [2,7-naphthalenesulfonic acid, 4-amino-5-hydroxy-3,6-bis((4-((2-(sulfooxy)ethyl)sulfonyl)phenyl)azo)-tetrasodium salt].

In various embodiments, reactive dyes, after fixing become chemically bonded to the surface of the lens, so that the lens is colorfast and the dye is non-extractable. Other types of dyes, e.g. vat dyes, water-soluble dyes, water-insoluble dyes which may be disbursed in a matrix polymer and polymer-bound dyes have also been suggested as colorants for soft contact lenses. For various reasons, reactive dyes are preferred for the present invention, but other colorants may be used. Reactive dyes are colorfast and can be provided in optical densities sufficient to impart desired tinting to a soft contact lens.

Additionally, in various embodiments, contact lenses made of low consistency elastomers such as polydimethylsiloxane may be used and colored using compatible medical grade colorants such NUSIL Med 4800-X, comprised of a vinyldimethyl-terminated polydimethylsiloxane polymer. See http://nusil.com/product/med-4800-x_color-masterbatches-for-liquid-silicone-elastomers and http://nusil.com/product/med-4800-x_color-masterbatches-for-liquid-silicone-elastomers.

In various embodiments, the full lens may have uniform filtering or a central area only may contain the colorant. In one embodiment, a central area having a diameter ranging from about 3 mm to 13 mm is fabricated by a two-step molding process wherein the central colored portion is first molded with the PDMS and colorant, followed by a second step of molding the clear portion outside the colored portion. The clear PDMS may also encapsulate the colored central area.

An alternate method including steps of (a) fabricating a disc of colored PDMS, (b) thermoforming the colored disc, (c) placing the disc within a mold, and (4) molding the clear PDMS to surround or encapsulate the disc of colored PDMS.

As mentioned above, embodiments of the present disclosure are directed toward at least one ophthalmic lens (e.g., spectacle lens 105 or contact lens 205) positioned between the wearer's eye and natural or artificial light sources. This lens features a spectral transmission intended to transmit the greater portion of the visible spectrum from about 500 nm to about 700 nm while blocking more than about 50% of a bandwidth including about 405 nm and while transmitting more than about 50% of the bandwidth between about 460 and about 500 nm.

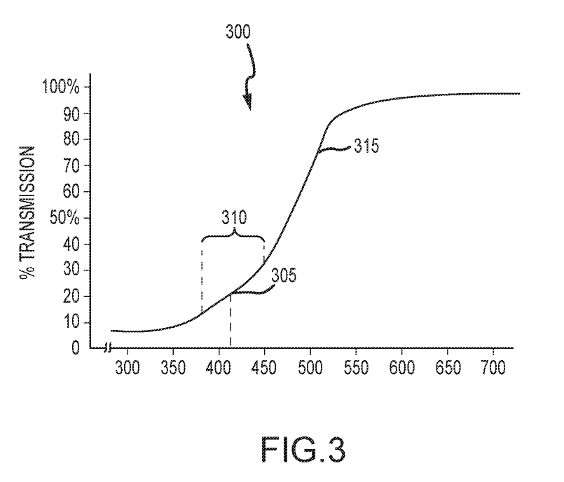

With reference now to FIG. 3, a spectral transmission graph 300 of a filter representative of an embodiment of the present disclosure is illustrated showing the center 305 at about 405 nm of a bandwidth 310 showing transmission is reduced by greater than about 50% while the transmission 315 at a wavelength of about 460 nm is greater than about 50%.

A lens with this spectral transmission helps block light in the range of 405 nm. In this example, the bandwidth of the blue band filter is approximately 40 nm and blocks between about 82% and about 65% of the band from about 385 nm to about 425 nm The transmission of the 450 to 500 nm band progresses from about 45% to about 87%. A filter having this spectral characteristic transmits the red, green and blue light as mixed and emitted by the electronic display, while blocking more than about 50% of the hazardous electromagnetic radiation between about 385 nm and about 450 nm. In other embodiments, a different filter can be employed that blocks more of the broadband light. For example, such a filter can permit not more than about 20% transmission of broadband light, or not more than about 50% transmission or not more than about 70% of broadband light.

Since the total width of the blocked light with a transmission of less than about 50% is approximately 60 nm and since the visible spectrum is estimated to range from about 400 to about 700 nm, the total reduction in transmission of the visible spectrum is less than about 15%. The resulting high transmission rate of the broadband light relative to the filtered hazardous blue light allows a wearer to view the surrounding environment in dim artificial light and outdoor night-time conditions.

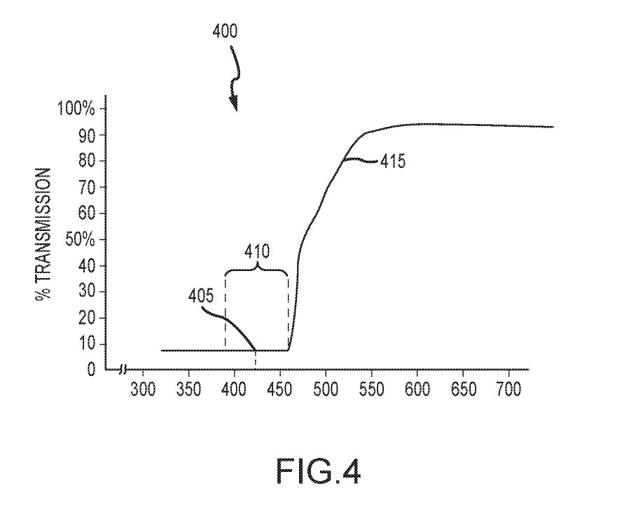

With reference now to FIG. 4, a graph 400 illustrating the spectral transmission of a filter representative of an embodiment of the present disclosure is shown wherein the center 405 at about 405 nm of the a bandwidth 410 showing transmission is reduced by greater than fifty percent to a transmission of about 40%, while the transmission 415 at a wavelength of about 460 nm is greater than about 50%. A lens with this spectral characteristic transmits less than about 10% of the bandwidth surrounding about 405 nm, and transmits between about 10% and about 45% of the bandwidth from about 435 to about 450 nm. The transmission of the about 450 to about 500 nm bands progresses from about 45% to about 87%.

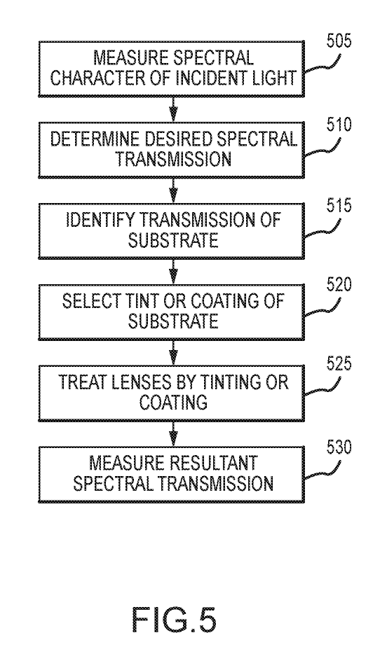

FIG. 5 illustrates a flow diagram of the system and method for determining the filtering characteristics of lenses representative of an embodiment of the present disclosure wherein the step of measuring the spectral character of the ambient light 505; followed by the step of determining the desired spectral transmission for the respective eye of a user 510; followed by the step of measuring or looking up of the spectral transmission of the lens substrate 515; followed by the step of selecting a tinting or coating for the substrate that will produce the desired spectral transmission of the finished lens 520; followed by the step of treating the lens by tinting, coating or addition of photochromic or electrochromic properties 525; and followed by the of measuring the resultant spectral transmission of the lens 530 to verify the desired spectral transmission for the user has been achieved. The steps of

FIG. 5 can be done, for example, using spectral meters, output graphs, algorithms to determine filter requirements, computer programs and look up tables to display the required filter spectral characteristics, and a filter name or numerical designations.

In various embodiments, the ophthalmic lenses may be non-prescription or may be made according to a prescription containing spherical lenses and/or cylindrical lenses for the correction of nearsightedness (e.g., myopia), farsightedness (e.g., hyperopia), astigmatisms (e.g., caused by asymmetry of the eye), presbyopia (e.g., caused by loss of elasticity by the lens of the eye), or the like.

The lenses may be single vision or multifocal lenses and may be designed to correct higher order aberrations as measured with an aberrometer. The lenses may incorporate vertical and/or horizontal prism for the correction of binocular imbalances.

An ophthalmic lens in accordance with an embodiment of the present disclosure can have varying amounts of filtering greater than 50% of the hazardous blue light bandwidth to provide protection in the form of an individual filter prescription respective to the blue light hazard found in the environment of the individual. Since the blue light emitted from electronic displays can vary widely, some individuals will require more filtering than others. For example, some blue light emitting diodes are known to emit more high energy blue light than others. In some such embodiments, the same filtered band widths are selected while the transmission is reduced for the lenses of the present disclosure. By way of example, the transmission for the 400 to 440 nm bandwidth is reduced to less than 10%.

In yet another embodiment, the blue bandwidth is reduced in response to a measurement of the intensity of the blue light bandwidth directed toward the eye of the wearer. For example, a meter may be used in the environment of the wearer and the respective filter prescription is selected by use of the measurement. By way of example, the ILT 1700 Radiometer/Photometer/Optometer may be used to measure the blue light hazard incident on an eye in at least one environmental setting of the individual. (International Light Technologies, Inc. Peabody, Mass. (ILT1700, SED033/SCS395/TBLU/TD). Accordingly, the spectral character and transmission of an embodiment of the present disclosure is selected to reduce the exposure of a bandwidth between about 400 and about 460 nm to a pre-determined level wherein the filtering is greater than 50%.

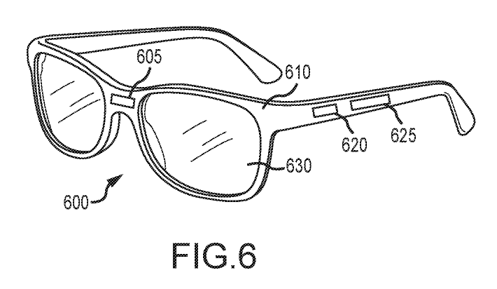

In another embodiment, a frame mounted sensor measures the spectral character of the light. The sensor transmits a signal to a processor that controls an electrochromic lens. The electrochromic lens changes the filtering and resultant transmission of the blue light bandwidth as described above. By way of example, an electrochromic lens using technology as taught by U.S. Patent Application 2012/0307339 or other technologies could be employed. For example, FIG. 6 illustrates an embodiment of spectacle lens ophthalmic eyewear 600 comprising a sensor 605, a processor 620, a power source 625, and an electrochromic lens 630 according to an embodiment of this disclosure.

One skilled in the art will appreciate that the embodiments of the present disclosure can be practiced by other than the various embodiments and preferred embodiments, which are presented in this description for purposes of illustration and not of limitation, and the present disclosure is limited only by the claims that follow. It is noted that equivalents for the particular embodiments discussed in this description may fall within the scope of the present disclosure as well.

While various embodiments of the present disclosure have been described above, it should be understood that they have been presented by way of example only, and not of limitation. Likewise, the various diagrams may depict an example architectural or other configuration for the present disclosure, which is done to aid in understanding the features and functionality that may be included in the present disclosure. The present disclosure is not restricted to the illustrated example architectures or configurations, but the desired features may be implemented using a variety of alternative architectures and configurations. Indeed, it will be apparent to one of skill in the art how alternative embodiments may be implemented to achieve the desired features of the present disclosure. Also, a multitude of different constituent part names other than those depicted herein may be applied to the various parts of the devices. Additionally, with regard to operational descriptions and method claims, the order in which the steps are presented herein shall not mandate that various embodiments be implemented to perform the recited functionality in the same order unless the context dictates otherwise.

Although the present disclosure is described in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present disclosure, whether or not such embodiments are described and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof;

the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. Ophthalmic eyewear, comprising:
a frame;
at least one spectacle lens disposed within the frame; and
the at least one spectacle lens having a filter, wherein the filter has greater than about 50% reduction of transmission of blue light in the band from about 400 to about 450 nm, and wherein the filter has greater than about 50% transmission of blue light in the band from about 460 to about 500 nm.

2. The ophthalmic eyewear of claim 1, wherein the filter covers a surface of the spectacle lens.

3. The ophthalmic eyewear of claim 1, wherein the filter is an electrochromic filter.

4. The ophthalmic eyewear of claim 1, wherein the filter transmits a color balance bandwidth which allows proper color balance and contrast when viewing of a computer display.

5. The ophthalmic eyewear of claim 1, wherein the filter transmits a circadian rhythm bandwidth which allows maintenance of proper circadian rhythms.

6. The ophthalmic eyewear of claim 1, wherein the filter blocks substantially all of light with a bandwidth shorter than about 400 nm.

7. The ophthalmic eyewear of claim 1, wherein the filter specification is chosen based on a measured presence of hazardous blue light in a visual environment of a user.

8. The ophthalmic eyewear of claim 1, wherein the at least one spectacle lens has a prescribed power.

9. Ophthalmic eyewear, comprising a contact lens having a filter, wherein the filter has greater than about 50% reduction of transmission of blue light in the band from about 400 to about 450 nm, and wherein the filter has greater than about 50% transmission of blue light in the band from about 460 to about 500 nm.

10. The ophthalmic eyewear of claim 9, wherein the filter covers a central portion of the contact lens and a peripheral portion of the contact lens is uncovered by the filter.

11. The ophthalmic eyewear of claim 9, wherein the contact lens comprises at least one of a soft lens, rigid lens, hybrid lens, intracorneal lens, corneal onlay, and intraocular lens.

12. The ophthalmic eyewear of claim 9, wherein the filter transmits a color balance bandwidth which allows proper color balance and contrast when viewing of a computer display.

13. The ophthalmic eyewear of claim 9, wherein the filter transmits a circadian rhythm bandwidth which allows maintenance of proper circadian rhythms

14. The ophthalmic eyewear of claim 9, wherein the filter blocks substantially all of light with a bandwidth shorter than about 400 nm.

15. The ophthalmic eyewear of claim 9, wherein the filter specification is chosen based on a measured presence of hazardous blue light in a visual environment of a user.

16. The ophthalmic eyewear of claim 9, wherein the contact lens has a prescribed power.

17. A method of selecting a filter for reducing the transmission of blue light in the band from about 400 to about 450 nm by more than about 50% reduction and also more than about 50% transmission of blue light in the band from about 460 to about 500 nm, comprising the steps of:
measuring the spectral character of ambient light in a user environment;
determining a desired spectral transmission for an eye of the user;
determining a desired spectral transmission of a lens;
selecting a filter that will provide the determined spectral transmission of the lens;
applying the selected filter to the lens; and
measuring a resultant spectral transmission of the lens to verify the desired spectral transmission for the user has been achieved.

18. The method of selecting a filter of claim 17, wherein the filter is applied by at least one of tinting, coating, adding photochromic materials, and adding electrochromic properties.
